(19) United States
(12) Patent Application Publication
(10) Pub. No.: US 2026/0211371 A1
(43) Pub. Date: Jul. 23, 2026

(54) CONSTANT-FORCE ESCAPEMENT MECHANISM FOR TIMEPIECE MOVEMENT

(71) Applicant: GREUBEL FORSEY S.A., La Chaux-de-Fonds (CH)

(72) Inventors: Stephen FORSEY, Les Brenets (CH); Robert GREUBEL, Le Locle (CH); Florian CORNEILLE, Mathay (FR)

(21) Appl. No.: 19/140,864

(22) PCT Filed: Dec. 15, 2023
(86) PCT No.: PCT/EP2023/086118

§ 371 Date: Jun. 18, 2025

(30) Foreign Application Priority Data
Dec. 20, 2022 (FR) 22215169.8

(51) Int. Cl. G04B 15/10; G04B 15/08; G04B 15/12

(52) U.S. Cl. CPC G04B 15/10; G04B 15/08; G04B 15/12

(57) ABSTRACT

The invention relates to a constant-force escapement mechanism (1) for a timepiece comprising:—an escapement wheel (3) that has a plurality of teeth and is arranged to maintain a spring-balance oscillator (5, 7);—a winding wheel (11) that has a plurality of teeth and is arranged to be rotated by a drive source, the winding wheel (11) being connected to the escapement wheel (3) via a return element (21);—a locking pallet fork (25) that is pivotably mounted and arranged to move between a first stable angular position and a second stable angular position according to the rotation of the escapement wheel (3), and to lock and release the winding wheel (11) at a rate of one step in its rotation as the locking pallet fork (25) moves from one of its stable positions to the other. According to the invention, the escapement mechanism (1) further comprises a control wheel (15) that rotates as one with the escapement wheel (3) and is mounted so as to be angularly adjustable relative to the latter. the control wheel (15) having a plurality of teeth and being arranged to engage with the locking pallet fork (25) in order to move it between one of its stable positions to the other.

### TECHNICAL FIELD

The present invention relates to the field of watchmaking. It relates, more particularly, to a constant-force escapement mechanism.

### PRIOR ART

The escapement mechanism that forms the subject of the present invention is based on that initially disclosed by document CH353679 and developed further in document CH704275. Furthermore, an escapement of this type was also used in a timepiece produced by Fabrication de Montres Normandes [Normandy Watchmakers] in 2009 (see https://forumamontres.forumactif.com/t68941-fabrication-de-montres-normandes).

In this type of escapement, the escape wheel is coaxial with a rearming wheel, which appears at first glance to be an additional escape wheel. The rearming wheel is fixed in rotation to a wheel or pinion that receives the torque coming from the barrel, while the escape wheel is mounted so that it is free to rotate around the same geometric axis. These two wheels are connected to each other by means of an elastic return element, such that the escape wheel is driven in rotation by this element.

The escape wheel cooperates with an anchor in a conventional manner, and also cooperates with a blocking lever which has two levels of pallets, of which the pallets of a first level cooperate with the teeth of the escape wheel while the pallets of a second level cooperate with those of the rearming wheel in order to block and release them alternately as it moves from one of its stable positions to the other.

Following each release of the pallet assembly and during pivoting of the escape wheel, one of the teeth of the latter comes into contact with one of the pallets of the first level in order to trigger a pivoting of the blocking lever from one of its stable positions to the other. In doing so, the rearming wheel pivots under the effect of the drive spring housed in the barrel and arms the elastic element, before being reblocked by the blocking lever.

In doing so, during operation of the escapement, the rearming wheel advances incrementally in steps in synchronism with the escape wheel, thereby ensuring that the force provided by the elastic element remains substantially constant and that the escapement is not subjected to variations in torque as the drive spring unwinds. Since the advances of the rearming wheel take place between those of the escape wheel with an angular and temporal offset, the latter advances take place when the anchor is not cooperating with the balance wheel, thereby minimizing or eliminating the disturbance of the latter.

A first disadvantage of this system is that the moment of release of the blocking lever with respect to that of the escape wheel is predetermined by the geometry of the blocking lever (including its pallets) and by the positioning of its pivot axis. Consequently, it is impossible to regulate the moment of release of the rearming wheel (and therefore its phase-shift with respect to the escape wheel) other than by modifying the geometry of the blocking lever. Secondly, the angular movements of the blocking lever interfere with the functioning of the escapement. Specifically, when the lever comes into abutment at the end of its travel, shocks are produced and cause it to rebound.

Document CH120028 discloses a constant-force escapement in which the rearming wheel is a star with three points which are blocked and released by a blocking lever controlled by a constant-radius cam rotationally integrated with the escape wheel. The constant-radius cam is monobloc with a staff, to which the escape wheel is riveted. This arrangement, as well as those disclosed by documents U.S. Pat. No. 2,970,427 and FR1009853, have the same defects as mentioned above.

It is therefore the object of the invention to propose a constant-force escapement mechanism in which the aforementioned defects are at least partially overcome.

### DISCLOSURE OF THE INVENTION

More specifically, the invention relates to a constant-force escapement mechanism for a timepiece, as defined in a first independent claim. This mechanism comprises:
an escape wheel having a plurality of teeth and arranged to sustain a hairspring-balance oscillator in known manner, typically via a Swiss anchor or other;
a rearming wheel having a plurality of teeth and arranged to be driven in rotation by a drive source such as a mainspring housed in a barrel, or any other known drive source, said rearming wheel being connected to said escape wheel by means of a return element, which may be formed by a spiral spring, another type of spring, a flexible guide system integrated into either one of these wheels, or any other suitable element;
a blocking lever pivotably mounted so that it can pivot about a physical or virtual axis and arranged to move between stable first and second angular positions as a function of the rotation of said escape wheel, and to block and release said rearming wheel at the rate of one step of its rotation (namely typically at the rate of half a tooth pitch of its toothset) as said blocking lever moves from one of its stable positions to the other.

According to a first aspect of the invention, said escapement mechanism further comprises a control wheel mounted fixed in rotation to said escape wheel and angularly adjustable with respect to the latter, said control wheel having a plurality of teeth and being arranged to cooperate with said blocking lever in order to cause it to move between one of its stable positions and the other. Typically, the profile of all of said teeth is identical, and each wheel has the same number of teeth, but this does not necessarily have to be the case.

Since the angular position of the control wheel can be adjusted with respect to the escape wheel, the exact moment of release of the blocking lever can be modified by the watchmaker to optimize the operation of the escapement mechanism for each individual escapement, thus improving performance and/or running.

Advantageously, said control wheel is arranged between said escape wheel and said rearming wheel, this representing the simplest solution to implement, but other configurations of the three wheels are also possible.

Advantageously, said rearming wheel is fixed in rotation to a pinion arranged to be driven in rotation by said drive source, said pinion being extended by a staff about which there is mounted, freely in rotation, an assembly comprising said control wheel and said escape wheel.

Advantageously, said escape wheel is rotationally fixed to said control wheel by means of at least one adjusting screw or as a friction fit by means of a friction element.

Advantageously, said blocking lever has a plurality of pallets arranged to cooperate with, on the one hand, the rearming wheel and, on the other hand, the control wheel, each pallet having a trapezoidal cross section. This allows the use of the same standard pallets for each pallet.

Advantageously, the toothsets of the escape wheel, of the rearming wheel and of the control wheel are substantially identical, or alternatively simply comprise the same number of teeth but of different profiles.

In another variant, said rearming wheel has the same number of teeth as said control wheel, but a smaller number of teeth than said escape wheel. In such a case, the toothsets of the rearming wheel and of the control wheel are evenly distributed around each wheel and have the same theoretical tooth pitch as the escape wheel, but with some of the teeth omitted. This means that the blocking lever is triggered after a predetermined number of incremental steps of the escape wheel rather than on each incremental step of the latter.

According to another aspect, the invention also relates to a constant-force escapement mechanism for a timepiece, as defined in a second independent claim. This escapement mechanism comprises:
an escape wheel having a plurality of teeth and arranged to sustain a hairspring-balance oscillator in a known manner, typically via a Swiss anchor or other;
a rearming wheel having a plurality of teeth and arranged to be driven in rotation by a drive source such as a mainspring housed in a barrel, said rearming wheel being connected to said escape wheel by means of a return element, which may be formed by a spiral spring, another type of spring, a flexible guide system integrated into either one of these wheels, or any other suitable element;
a blocking lever pivotably mounted so that it can pivot about a physical or virtual axis and arranged to move between stable first and second angular positions as a function of the rotation of said escape wheel, and to block and release said rearming wheel at the rate of one incremental step of its rotation (namely typically at the rate of half a tooth pitch of its toothset) as said blocking lever moves from one of its stable positions to the other.

According to this aspect of the invention, said blocking lever cooperates with a flywheel which is separate from the hairspring-balance oscillator, that is to say it is a component that is separate from and independent of this assembly and which is therefore neither the balance nor its table roller. Typically, the flywheel is not coaxial with the hairspring-balance oscillator.

This flywheel increases the effective inertia of the blocking lever and makes it possible to smooth its movements, thereby improving the operation of the escapement compared with the abovementioned escapements of the prior art.

Advantageously, said flywheel is a rotatably mounted table roller, typically mounted on a frame element. This can notably allow the use of already-available standard components, including balance table rollers. Typically, said table roller comprises a pin which cooperates with a fork that is comprised by said blocking lever.

Advantageously, said blocking lever takes the form of an anchor. Once again, this allows the use of standard components that are already available.

Of course, the two aspects of the invention can be combined in the one same escapement mechanism.

### BRIEF DESCRIPTION OF THE DRAWINGS

Other details of the invention will become more clearly apparent on reading the following description, given with reference to the appended drawings in which:

FIG. 1 is an isometric view of a first embodiment of an escapement mechanism according to the invention;

FIG. 2 is a cutaway isometric view of the stack of wheels of the embodiment of FIG. 1;

FIG. 3 is a partial isometric view of a second embodiment of an escapement mechanism according to the invention.

### EMBODIMENTS OF THE INVENTION

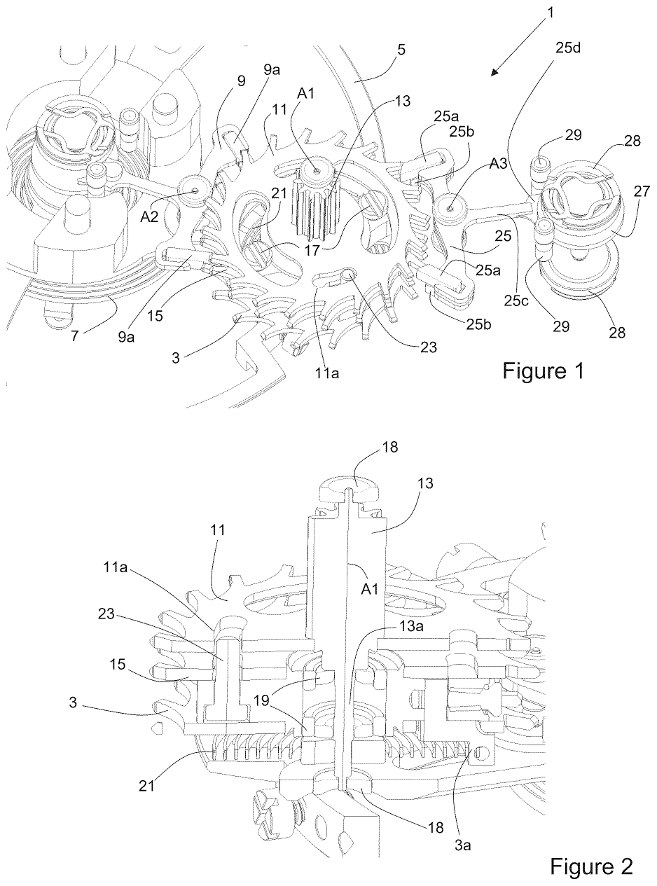

FIG. 1 illustrates a first embodiment of an escapement mechanism 1 according to the invention, while FIG. 2 illustrates the particular arrangement of the wheels that the mechanism 1 comprises.

This mechanism 1 comprises an escape wheel 3 pivotably mounted about an axis A1 and arranged to sustain the oscillation of a balance 5—hairspring 7 oscillator, which is arranged in such a way that said hairspring 7 exerts a return torque on said balance 5 in such a way as to cause the latter to oscillate around a neutral point, in a known manner.

In the embodiment illustrated, the escape wheel 3 cooperates with an anchor 9 of the Swiss type, pivotably mounted about an axis A2. This escape wheel 3 is arranged to be blocked and released by the pallet assembly 9, as well as to supply impulses to the balance 5 in a known manner. However, a detent escapement system, an Omega-Daniels escapement or any other type of escapement known to those skilled in the art may be used. Thus the assembly comprised of the escapement mechanism 1, the balance 5 and the hairspring 7 forms a regulating system.

The escape wheel 3 is coaxial with a rearming wheel 11, which comprises a plurality of teeth and is rotationally integrated with a pinion 13 which serves as a force input from the drive source (not illustrated, typically a barrel housing a mainspring in a known manner). This pinion 13 acts as an escape pinion, and is kinematically connected to said drive source by a suitable geartrain (typically called a “finishing gear”).

The escape wheel 3 is rotationally integrated with a control wheel 15, which may be angularly offset with respect to the escape wheel 3. In the embodiment illustrated, adjusting screws 17 serve to fix the two wheels 3, 15 together in terms of rotation, but by unscrewing them, the watchmaker can move one of these wheels 3, 15 angularly with respect to the other for reasons which will become more clearly apparent later. Alternatively, the two wheels 3, 15 can be fitted together as a friction fit, provided that they remain rotationally fixed with respect to one another during normal operation of the escapement 1. Any known type of friction connection between the wheels 3 and 15 can be envisaged, provided that the friction torque is determined accordingly.

The assembly comprising the escape wheel 3 and the control wheel 15 is mounted so as to be free to rotate with respect to the assembly comprising the rearming wheel 11 and the pinion 13. To this end, the pinion 13 is extended by a staff 13a which extends through the wheels 3, 15 and supports this assembly between first bearings 18. The assembly comprising the wheels 3, 15 is mounted so as to be free to pivot about this staff 13a by means of second bearings 19 which surround this latter.

The rearming wheel 11 is connected to the escape wheel 3 by means of a return element 21, here a spiral spring, which is preloaded in order to provide sufficient torque to cause the escape wheel 3 to pivot and sustain the oscillator 5, 7. To this end, the inner end of the return element 21 is rotationally fixed with respect to the staff 13a (which, remember, is rotationally fixed with respect to the rearming wheel 11), while its outer end is fixed to a stud 3a secured to the escape wheel 3. Consequently, the assembly comprising the two wheels 3, 15 is kinematically connected to the assembly comprising the rearming wheel 11 and the pinion 13 by means of this return element 21, which ensures that the torque to which the escape wheel 3 is subjected remains substantially constant insofar as the return element 21 can be recharged by the drive source.

In the illustrated construction, the control wheel 15 is interposed between the escape wheel 3 and the rearming wheel 11, and although the illustrated construction is the simplest to implement, the stacking of the wheels 3, 11, 15 along the axis A1 may be defined differently. Indeed, one or other of the wheels 3, 11 may be in the middle, and the control wheel 15 may be on one side or the other. To this end, provided that the assembly of wheels 3, 15 is connected to the assembly of the rearming wheel 11 and to the pinion 13 by means of the return element 21, the connection between these two assemblies may be arranged in a suitable manner, according to the requirements of the constructor. For example, one of the ends of the return element 21 may be fixed to one or other of the wheels 3, 15, while its other end may be fixed to the wheel 3 directly or to the staff 13a, depending on the configuration chosen. In addition, the return element 21 may alternatively be integrated into one or other (or even several) of the wheels 3, 11, 15 (in particular the rearming wheel 11 and/or the control wheel 15), by being made up of flexible elements (such as flexible blades) arranged in a suitable manner.

In order to maintain the preload of the return element 21 in the event that the drive source no longer supplies enough torque to the pinion 13 to completely re-tension the return element 21, a stud 23 carried by the assembly comprised of the escape wheel 3 and the control wheel 15 is provided, this stud 23 being positioned in a slot 11a comprised by the rearming wheel, in order to limit the angular phase shift between the wheels 3 and 11 and to preserve the pre-winding of the return element 21. Of course, other arrangements that make it possible to limit the angular offset between the two assemblies 11, 13 and 3, 15, respectively, in order to obtain the same result are also possible, for example that used in document CH704275.

A blocking lever 25 is arranged to block and release the rearming wheel 11 under the control of the control wheel 15, which pivots in function of the escape wheel 3. To this end, the blocking lever 25 is pivotably mounted so that it can pivot about an axis of rotation A3 (which can be a traditional physical staff or a virtual axis in instances in which the blocking lever 25 is supported by a flexible guide), which is distinct from the axis A2, in such a way that it is arranged to pivot between a first and a second stable position (extreme positions), and comprises two pairs of pallets 25a, 25b, located on two different levels in order to cooperate respectively with the rearming wheel 11 and with the control wheel 15. The pallets 25a, 25b can take any suitable shape, and can be formed as one piece with the blocking lever 25 or can be made up of elements attached to said lever. In the non-limiting embodiment illustrated, they each assume a conventional trapezoidal shape (i.e. have a cross section perpendicular to the axis A3 which is trapezoidal), similar to that of a Swiss anchor escapement. In other words, they each comprise straight flanks connected by an end face forming an oblique impulse plane. The pallets 25a of the first level are of sufficient length for a straight flank of each pallet to be able to block the teeth of the rearming wheel 11 when the blocking lever 25 is in a corresponding extreme angular position, a flank of one of the pallets 25a thus lying in the path thereof. However, the pallets 25b are shorter than the pallets 25a (i.e. they extend less far from the blocking lever 25 than the latter pallets), such that only their oblique ends are able to penetrate into the path of the teeth of the control wheel 15 when the stop lever 25 is in a respective extreme angular position. As is the case for the pallets of an anchor, the flank of each pallet 25a, 25b, which is upstream (considered in relation to the direction of rotation of the wheels 3, 11, 15), is shorter than that which is downstream, such that the end face is configured to cause the blocking lever 25 to pivot when the teeth of the wheels 11, 15 cooperate with the end flanks of the pallets 25a, 25b.

The operation of the escapement is therefore as follows:

At rest, the escape wheel 3 is blocked by a flank of one of the pallets 9a of the pallet assembly 9, and the rearming wheel 11 is also blocked by a flank of one of the pallets 25a of the first level.

When the pallet assembly 9 allows a tooth of the escape wheel 3 to escape under the effect of the rotation of the balance, the escape wheel is free to pivot under the effect of the return element 21 until the flank of the other pallet 9a of the pallet assembly stops it, in a known manner. Because the control wheel 15 is fixed in terms of rotation to the escape wheel 3, it also pivots.

During this pivoting, a tooth of the control wheel 15 comes into contact with the end face of the pallet 25b which is adjacent to the pallet 25a which is engaged with a tooth of the rearming wheel 11. The cooperation between the tooth of the control wheel 15 and the oblique end face of the pallet 25b in question causes the blocking lever 25 to lift, and this causes the pallet 25a to disengage from the tooth of the rearming wheel 11 and causes the latter to pivot under the effect of the mainspring.

Cooperation between the tooth of the rearming wheel 11, which has just been released, and the oblique end face of the pallet 25a contributes to accelerating the pivoting of the blocking lever 25, and the flank of the other pallet 25a of the first level blocks the rotation of the rearming wheel 11.

By adjusting the angular position of the control wheel 15 with respect to the escape wheel 3, the watchmaker can determine the moment in the cycle at which the blocking lever 25 is pivoted in order to optimize the performance of the escapement mechanism 1, by optimizing the time that elapses between the release of the escape wheel 3 and that of the rearming wheel 11. Since the control wheel 15 is fixed in terms of rotation with respect to the escape wheel 3, the releases of the rearming wheel 11 are always dependent on the rotations of the escape wheel 3, even if it is the teeth of the control wheel 15 which control the pivoting of the blocking lever 25.

In order to smooth the operation of the blocking lever 25, the latter takes the form of an anchor, of which the fork lever 25c carries a fork 25d which cooperates with a pin (not visible) of a table roller 27 of a type which is well known in the context of a balance, pivoted between standard bearings 28. The latter acts as a flywheel and makes it possible to increase the effective inertia of the blocking lever 25 and to smooth its movements, thereby improving the operation of the escapement 1 compared to those of documents CH353679 and CH704275. This flywheel counteracts the dynamic effects of shocks when the blocking lever rebounds, in particular when it comes into abutment against the banking pins 29 or during contacts between fork and impulse pin.

However, it is also possible to use a simple lever for the blocking lever 25, as is the case in documents CH353679 and CH704275, or any other form of lever adapted accordingly.

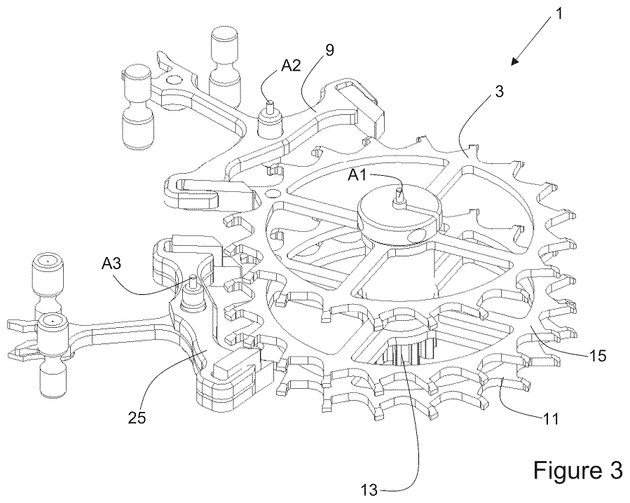

FIG. 3, in which only the main reference signs have been used and certain elements (including the return element 21) have been omitted, illustrates another embodiment of an escapement mechanism 1 according to the invention. The latter differs from that of FIG. 1 in terms of the positioning of the axis A2 with respect to the axis A1. In the embodiment of FIG. 1, the angle between the straight lines connecting the axes A2-A1 and A3-A1 is obtuse; in the embodiment of FIG. 3 it is acute, such that the two axes A2, A3 lie on the same side of the mechanism, considered in the plane of the latter.

In a variant that has not been illustrated, it is also possible for the axes A2 and A3 to be coincident, so that the pallet assembly 9 and the blocking lever 25 are coaxial and superposed.

It will be noted that, in the embodiments illustrated, the three wheels 3, 11, 15 can be substantially identical, or at least have toothsets of substantially identical shapes. In addition, the pallet assembly 9 and the blocking lever 25 may also be identical, except for an attached or thickened part for carrying one of the pairs of pallets 25a, 25b. Furthermore, the pallets 9a, 25a, 25b can be of conventional and identical shape, except for the length of the pallets 25b. The number of different parts that need to be manufactured can thus be minimized. The shape of the toothset of the control wheel 15 and/or of the rearming wheel 11 may be chosen at will, and does not necessarily have to be conventional. In addition, the rearming wheel 11 and/or the control wheel 15 may be made up of any type of element suitable for producing the operation described, such as for example a wheel with edge teeth, a wheel in which the teeth are constituted by pins, fingers or the like, “teeth” therefore being to be understood in the broad sense to encompass all the less common variations known to those skilled in the art. The wheels 11, 15, or the wheels 3, 15, may also be made as one piece with each other, the connection between the two being by means of flexible elements, such as flexible blades. In the case in which the wheels 11, 15 are made in one piece, the flexible elements connecting them can also serve as a return element 21.

Furthermore, by reducing the number of teeth on the rearming wheel 11 and by removing one tooth in two from the control wheel 15, or two teeth in three, three teeth in four, four teeth in five, etc. with respect to the teeth of the escape wheel 3, the number of alternations of the balance between each rearming of the return element 21 can be increased, in the same way as in a constant-force device.

As far as materials are concerned, the full range of materials used in contemporary watchmaking can be considered (metals, non-metals such as silicon, silicon compounds, synthetic diamond, sapphire, structurable glasses, ceramics, glass-ceramics, metallic glasses, polymers, composites, materials capable of additive manufacture, etc.), and it should be noted that the pallets 9a, 25a, 25b may not only be separate parts attached to the pallet assembly 9, and the lever 25 respectively, but may be formed as one piece with said pallet assembly/lever.

The escapement mechanism 1 according to the invention is also compatible with an inclined balance and can be integrated into a tourbillon mechanism, whether of the monoaxial, biaxial or triaxial type, but also into a carousel mechanism.

The present description has been given by way of non-limiting illustration of the invention. A person skilled in the art will be able to make additions to its scope, without, however, departing from the scope of the invention defined by the claims.

1-15. (canceled)

16. Constant-force escapement mechanism for a timepiece, comprising:
an escape wheel having a plurality of teeth and arranged to sustain a hairspring-balance oscillator;
a rearming wheel having a plurality of teeth and arranged to be driven in rotation by a drive source, said rearming wheel being connected to said escape wheel by means of a return element;
a blocking lever pivotably mounted and arranged to move between stable first and second angular positions as a function of the rotation of said escape wheel, and to block and release said rearming wheel at the rate of one step of its rotation as said blocking lever moves from one of its stable positions to the other;
wherein said escapement mechanism further comprises a control wheel mounted fixed in rotation to said escape wheel and angularly adjustable with respect to the latter, said control wheel having a plurality of teeth and being arranged to cooperate with said blocking lever in order to cause it to move between one of its stable positions and the other.

17. Escapement mechanism according to claim 16, wherein said control wheel is arranged between said escape wheel and said rearming wheel.

18. Escapement mechanism according to claim 16, wherein said rearming wheel is fixed in rotation to a pinion arranged to be driven in rotation by said drive source, said pinion being extended by a staff about which there is freely rotationally mounted an assembly comprising said control wheel and said escape wheel.

19. Escapement mechanism according to claim 16, wherein said escape wheel is rotationally fixed to said control wheel by means of at least one adjusting screw or as a friction fit.

20. Escapement mechanism according to claim 16, wherein said blocking lever has a plurality of pallets arranged to cooperate with said rearming wheel and said control wheel, each pallet having a trapezoidal cross section.

21. Escapement mechanism according to claim 16, wherein the toothsets of the escape wheel, of the rearming wheel and of the control wheel are substantially identical.

22. Escapement mechanism according to claim 16, wherein said rearming wheel has the same number of teeth as said control wheel, but a smaller number of teeth than said escape wheel.

23. Constant-force escapement mechanism for a timepiece, comprising:
an escape wheel having a plurality of teeth and arranged to sustain a hairspring-balance oscillator;
a rearming wheel having a plurality of teeth and arranged to be driven in rotation by a drive source, said rearming wheel being connected to said escape wheel by means of a return element;
a blocking lever pivotably mounted and arranged to move between stable first and second angular positions as a function of the rotation of said escape wheel, and to block and release said rearming wheel at the rate of one step of its rotation as said blocking lever moves from one of its stable positions to the other;
wherein said blocking lever cooperates with a flywheel which is distinct from the hairspring-balance oscillator.

24. Escapement mechanism according to claim 23, wherein said flywheel is a rotatably mounted table roller.

25. Escapement mechanism according to claim 24, wherein said table roller comprises a pin which cooperates with a fork comprised by said blocking lever.

26. Escapement mechanism according to claim 25, wherein said blocking lever takes the form of an anchor.

27. Escapement mechanism according to claim 16.

28. Regulating system comprising an escapement mechanism according to claim 16 as well as a balance arranged to cooperate with said anchor and a hairspring arranged to exert a return torque on said balance.

29. Regulating system comprising an escapement mechanism according to claim 23 as well as a balance arranged to cooperate with said anchor and a hairspring arranged to exert a return torque on said balance.

30. Timepiece movement comprising a regulating system according to claim 28.

31. Timepiece movement comprising a regulating system according to claim 29.

32. Timepiece comprising a timepiece movement according claim 30.

33. Timepiece comprising a timepiece movement according claim 31.
